(19) United States
(12) Patent Application Publication
(10) Pub. No.: US 2006/0218620 A1
(43) Pub. Date: Sep. 28, 2006

(54) Network digital video recorder and method

(76) Inventors: Dinesh Nadarajah, Austin, TX (US); Sreenivasa Rao Gorti, Austin, TX (US); David Patron, Cedar Park, TX (US); Michael F. Grannan, Austin, TX (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/071,892

(22) Filed: Mar. 3, 2005

(51) Int. Cl. H04N 7/16

(52) U.S. Cl. 725/151

(57) ABSTRACT

A network digital video recorder has a number of set top boxes each having an individual digital video recorder. A peer-to-peer network connects the set top boxes. A digital rights management client operates on the set top boxes. An electronic rights server is coupled to the peer-to-peer network.

### RELATED APPLICATIONS

None

### FIELD OF THE INVENTION

The present invention relates generally to the field of digital video recorders and more particularly to a network digital video recorder and method.

### BACKGROUND OF THE INVENTION

Present digital video recorders (DVR) are used by their owners to record television programs that they will not be able to view at their normal time. In addition, people use their digital video recorders to record a program that conflicts with another program that they want to watch. However it a person forgets to setup their digital video recorder to record a program, there is no way for the person to view this past program.

In addition a user may record an event, such as a local kids' baseball game, and want to share this with his neighbors. Presently, the user must make copies of the video tape or DVD or risk losing the original.

Thus there exists a need for a system that allows a person to view past programs they forgot to record and to share copies of personal videos.

### SUMMARY OF INVENTION

A network digital video recorder that overcomes these and other problems has a number of set top boxes each having an individual digital video recorder. A peer-to-peer network connects the set top boxes. A digital rights management client operates on the set top boxes. An electronic rights server is coupled to the peer-to-peer network. A switched network is coupled to the electronic rights server and to the peer-to-peer network. A content index server is coupled to the peer-to-peer network. The set top boxes are coupled to a digital subscriber line access multiplexer. The set top boxes may be coupled to a cable television network. The set top box may nave an input for receiving and storing a personal video.

In one embodiment, a method of operating a network digital video recorder includes the steps of selecting a past program by a user at a first node. Next it is determined if the user is entitled to view the past program. When the user is entitled to view the past program, it is determined if a node of a peer-to-peer network contains the past program. When the node of the peer-to-peer network contains the past program, a copy of the past program is downloaded to the first node. The past program on a set top box coupled to a cable television network is selected. A client program to is activated to determine if the user is entitled to view the past program. A query may be transmitted over the peer-to-peer network for the past program. A query may be transmitted to an index server. A first node may be coupled through a digital subscriber line access multiplexer to the peer-to-peer network.

In one embodiment, a network digital video recorder has a number of set top boxes. Each of the set top boxes has an individual digital video recorder. A peer-to-peer network connects the set top boxes. An index server is coupled to the peer-to-peer network. The index server tracks the location of selections. A digital rights manager may be coupled to the peer-to-peer network. The digital rights manager may include a client on each of the set top boxes. The digital rights manager may include an electronic program guide index server. The set top boxes may each have an uplink port. The set top boxes may be coupled through a digital subscriber line access multiplexer to the peer-to-peer network.

### BRIEF DESCRIPTION OF THE DRAWINGS

FIG. 1 is a block diagram of a network digital video recorder in accordance with one embodiment of the invention;

FIG. 2 is a block diagram of a network digital video recorder in accordance with one embodiment of the invention;

FIG. 3 is a block diagram of a network digital video recorder in accordance with one embodiment of the invention;

FIG. 4 is a block diagram of a network digital video recorder in accordance with one embodiment of the invention; and

FIG. 5 is a flow chart of the steps used in a method of operating a network digital video recorder in accordance with one embodiment of the invention.

### DETAILED DESCRIPTION OF THE DRAWINGS

A network digital video recorder as described herein allows a user to view past programs that they forgot to record or to share home videos without having to make a copy or risk losing the original.

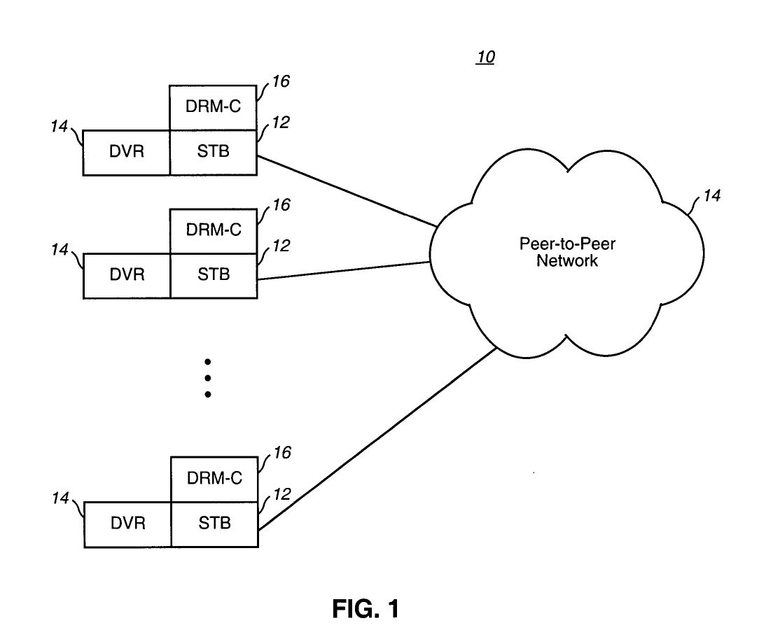

FIG. 1 is a block diagram of a network digital video recorder 10 in accordance with one embodiment of the invention. The system 10 has a number of set top boxes (STB) 12 coupled together by a peer-to-peer network 13. Each of the set top boxes 12 has an individual digital video recorder (DVR) 14. Note that the DVR 14 may be part of the set top box 12 or may be separate but electrically coupled to the set top box 12. The set top box 12 runs a digital rights management client (DRM-C) 16. The digital rights management client 16 defines what programs the set top box 12 is entitled to and may catalog the programs stored on the DVR 14. In one embodiment when a user fails to record a past program, he selects the past program for viewing from his set top box 12. The set top box 12 broadcasts a query over the peer-to-peer network 14 to determine if the past program is stored in on another of the DVRs 14. The DRM client 16 may also determine if the user is entitled to the program before transmitting the query. If the program is stored on another DVR 14, it responds to the query and a procedure is followed to download the past program over the peer-to-peer network to the user's digital video recorder 14. This system 10 expands the power of each of the individual DVRs 14 into a network DVR that has expanded storage and coverage of past programs while ensuring that users do not have access to programs which they are not entitled.

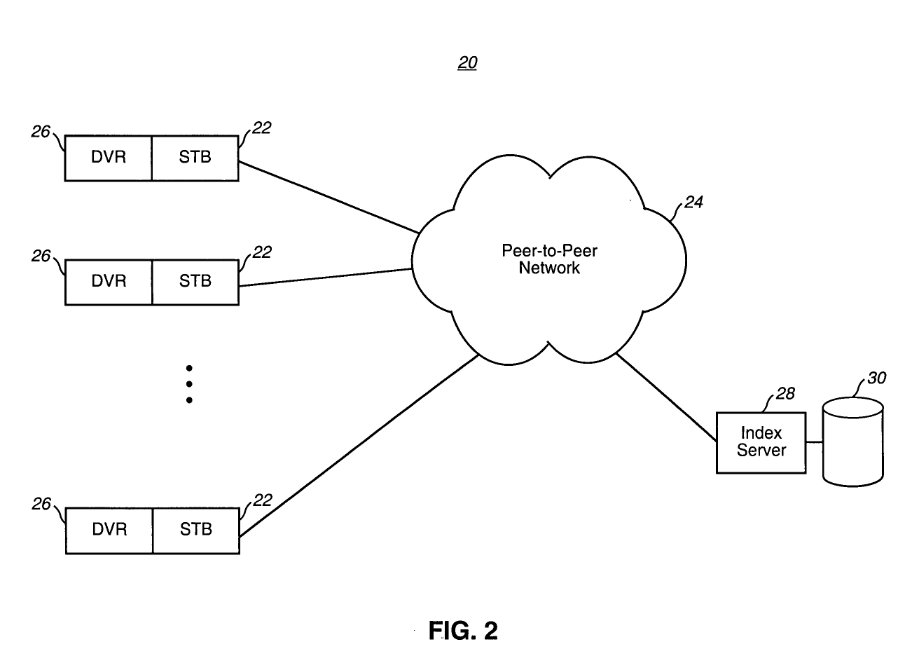

FIG. 2 is a block diagram of a network digital video recorder 20 in accordance with one embodiment of the invention. The system 20 has a number of set top boxes 22 coupled together by a peer-to-peer network 24. Each of the set top boxes 22 has a digital video recorder 26. The peer-to-peer network 24 is coupled to an index server 28. The index server 28 may have a database 30 associated with it. The index server 28 stores a list or index of all the stored past programs on the individual digital video recorders 26. This facilitates a search by a user for a past program.

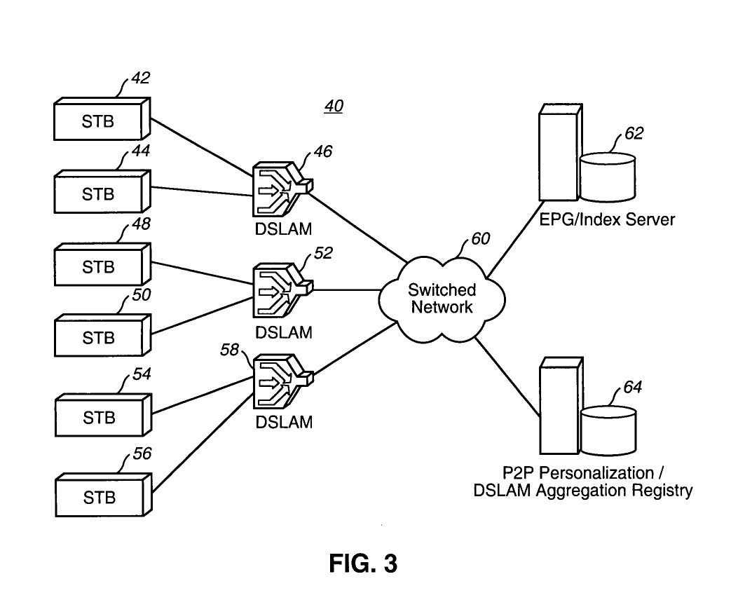

FIG. 3 is a block diagram of a network digital video recorder 40 in accordance with one embodiment of the invention. The system 40 has a number of set top boxes 42, 44 coupled to a first DSLAM (Digital Subscriber Line Access Multiplexer) 46. A second group of set top boxes 48, 50 are coupled to a second DSLAM 52. A third group of set top boxes 54, 56 are coupled to a third DSLAM 58. As will be apparent to those skilled in the art, there could be numerous set top boxes coupled to a single DSLAM and there could be a number of DSLAMs. The DSLAMs 46, 52, 58 are coupled to a switched network 60. The switched network couples an Electronic Program Guide/Index Sever (EPG) 62 to the DSLAMs 46, 52, 58. The EPG 62 is the electronic guide of the programs available for viewing. The EPG 62 includes programs presently playing, past programs and future programs. The past programs may only be viewed if the user is entitled to view the program and there is a copy of the program on one of the set top boxes 42, 44, 48, 50, 54, 56. A peer-to-peer (P2P) personalization/DSLAM aggregation registry 64 is coupled to the set top boxes 42, 44, 48, 50, 54, 56 through the switched network 60 and DSLAMs 46, 52, 58. The registry 64 contains a list of the copies of programs that are stored on the set top boxes 42, 44, 48, 50, 54, 56. The copies of programs may include home videos as well as copyrighted and broadcast programs. The programs may be video or audio programs.

The DSLAMs 46, 52, 58 serve to aggregate traffic in and out of the nodes (STB) 42, 44, 48, 50, 54, 56 in a specific proximity to a DSLAM. Since, DSLAMs are commonly deployed on a neighborhood basis they identify natural communities. The peer-to-peer content hosted on the nodes (STB) within a DSLAM area is generally of interest to other users on the same DSLAM. This makes it particularly advantageous for local or community content such as personal recordings of little league games, community video newsletters etc. Content downloaded from one node (STB) to another node (STB) on the same DSLAM does not have to traverse the network provider's backbone. The set top boxes are IP (Internet Protocol) based devices. Each set top boxes has a peer-to-peer software client. When a user's STB is provisioned for video service from a service provider (e.g., cable television) a service profile is downloaded onto the STB. The service profile is an XML description of the user's rights or entitlements in one embodiment. The service profile may also contain buddy lists, preference etc that the user has configured though a web interface. In one embodiment, the service entitlements group may have a service-ID (identification) to simplify subsequent searches. When a user wants to search for content, he uses the EPG (Electronic Program Guide) to pick a program to view (hear). If the program is a past program the peer-to-peer client is invoked to search the nodes on the peer-to-peer network. The query is limited by the entitlements, which may defined by the service ID, of the user requesting the past program. In one embodiment, this means that the user will not see any results for a program that they are not entitled to view. In another embodiment, the user will see the past program, but it will be shaded (or otherwise marked) so that the user knows they are not allowed access to the past program.

The query may be sent to a central index such as the registry 64. This requires that when a user records or stores a program on their STB a message is set to the registry 64 by the peer-to-peer client that the program is stored on a certain node. In another embodiment, the registry 64 may poll the STB 42, 44, 48, 50, 54, 56 for this information. In another embodiment, the query may be broadcast out over the peer-to-peer network. Note that local or privately made content can be uploaded to a STB.

In one embodiment, a user who hits record for a program that is already broadcasting will record locally the program from that point forward. The peer-to-peer client on their STB then transmits a query for the program to determine if the program was recorded from the beginning by another node. If the program was recorded by another node, the first part of the program is downloaded to the users' STB and merged with the locally recorded portion of the program.

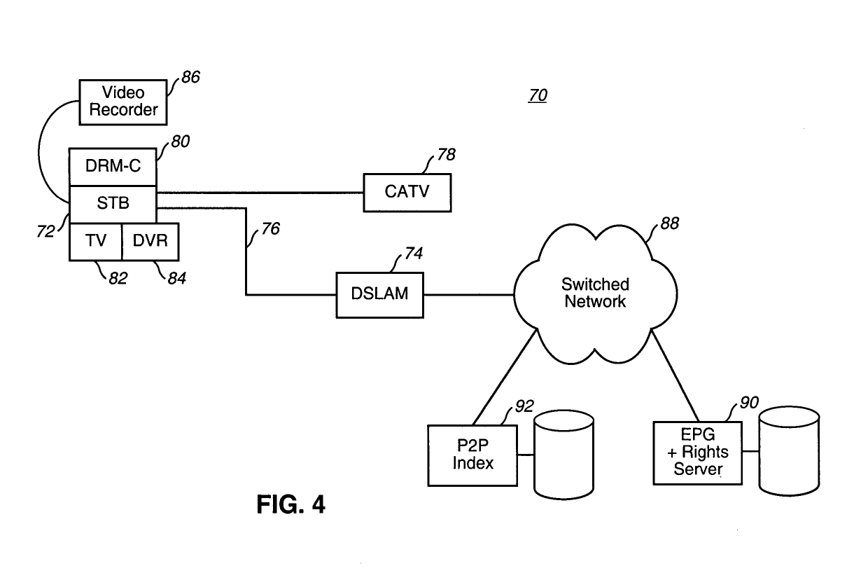

FIG. 4 is a block diagram of a network digital video recorder 70 in accordance with one embodiment of the invention. The system 70 has a number of set top boxes (only one is shown) 72 coupled to a DSLAM 74. The STB 72 is coupled to the DSLAM by a DSL (Digital Subscriber Line) 76. This link is used to create the peer-to-peer network. The STB 72 may also be coupled to a CATV (Cable TeleVision network) 78. The CATV 78 could also be used to provide the peer-to-peer network or the DSL 76 and DSLAM may be used to provide the channel to broadcast or distribute the programming. The STB 72 has a Digital Rights Management Client (DRM-C) 80 that may be part of a peer-to-peer client software. The DRM-C 80 ensures that the user does not obtain access to programs they are not entitled to view. There are number of methods of ensuring proper digital right management. Some are described above but the present application is not limited to a specific implementation. The STB 72 is coupled to a television 82 and a Digital Video Recorder 84. Note that the DVR 84 may be built into the STB. The STB 80 has a input that allows it to download private programs from a video recorder 86 or other recording device.

The DSLAM 74 is coupled by a switch network 88 to an EPG and rights server 90. The EPG 90 may contain a listing of the rights each STB 72 has to various programs. The switched network (packet switched or circuit switched???) 88 may also be coupled to a peer-to-peer index 92. The peer-to-peer index 92 stores an index of the programs that are stored on the DVR 84 of each node. A number of different methods may be used to update this index.

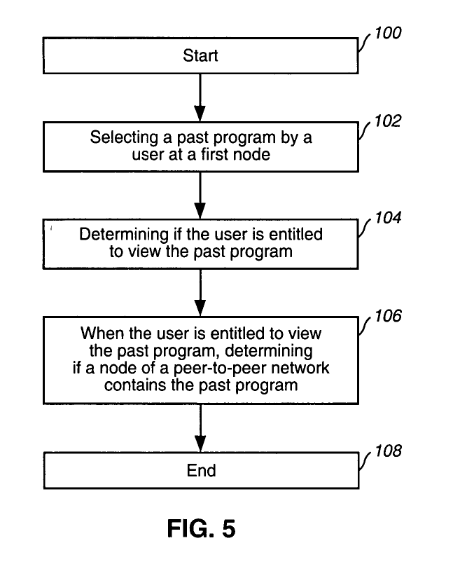

FIG. 5 is a flow chart of the steps used in a method of operating a network digital video recorder in accordance with one embodiment of the invention. The process starts, step 100, by selecting a past program by a user at a first node at step 102. Next it is determined if the user is entitled to view the past program at step 104. When the user is entitled to view the past program at step 106, it is determined if a node of a peer-to-peer network contains the past program which ends the process at step 108. If a node does contain the past program, it is downloaded to the user node or set top box. As a result, this system and method significantly increases the number of past programs that a user may have access to view or hear. This network of DVRs increases the utility of everyone's DVR. It also allows for easy sharing of personal (not copyrighted or broadcast) videos without the risk of losing the original copy.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A network digital video recorder, comprising:
a plurality of set top boxes each having an individual digital video recorder;
a peer-to-peer network coupling the plurality of set top boxes; and
a digital rights management client operating on each of the plurality of set top boxes.

2. The network digital video recorder of claim 1, further including an electronic rights server coupled to the peer-to-peer network.

3. The network digital video recorder of claim 2, further including a switched network coupling the electronic rights server to the peer-to-peer network.

4. The network digital video recorder of claim 1, further including a content index server coupled to the peer-to-peer network.

5. The network digital video recorder of claim 1, wherein the plurality of set top boxes are coupled to a DSLAM (Digital Subscriber Line Access Multiplexer).

6. The network digital video recorder of claim 5, wherein the set top boxes are coupled to a cable television network.

7. The network digital video recorder of claim 6, wherein the set top box has an input for receiving and storing a personal video.

8. A method of operating a network digital video recorder, comprising the steps of:
a) selecting a past program by a user at a first node;
b) determining if the user is entitled to view the past program;
c) when the user is entitled to view the past program, determining if a node of a peer-to-peer network contains the past program.

9. The method of claim 8, further including the step of:
d) when the node of the peer-to-peer network contains the past program, downloading a copy of the past program to the first node.

10. The method of claim 8, wherein step (a) further includes the step of:
a1) selecting the past program on a set top box coupled to a cable television network.

11. The method of claim 8, wherein step (b) further includes the step of:
b1) activating a client program to determine if the user is entitled to view the past program.

12. The method of claim 8 wherein step (c) further includes the step of:
c1) transmitting a query over the peer-to-peer network for the past program.

13. The method of claim 8 wherein step (c) further includes the step of:
c1) transmitting a query to an index server.

14. The method of claim 8, wherein step (a) further includes the step of:
a1) coupling a first node through a digital subscriber line access multiplexer to the peer-to-peer network.

15. A network digital video recorder, comprising:
a plurality of set top boxes each having an individual digital video recorder;
a peer-to-peer network coupling each of the plurality of set top boxes;
an index server coupled to the peer-to-peer network, the index server tracking a location of a plurality of selections.

16. The network digital video recorder of claim 15, further including a digital rights manager coupled to the peer-to-peer network.

17. The network digital video recorder of claim 16, wherein the digital rights manager includes a client on each of the plurality of set top boxes.

18. The network digital video recorder of claim 16, wherein the digital rights manager includes an electronic program guide index server.

19. The network digital video recorder of claim 15, wherein the plurality of set top boxes each have an uplink port.

20. The network digital video recorder of claim 15, wherein each of the set top boxes are coupled through a digital subscriber line access multiplexer to the peer-to-peer network.
